(19) United States
(12) Patent Application Publication
(10) Pub. No.: US 2024/0143981 A1
(43) Pub. Date: May 2, 2024

(54) COMPUTER-READABLE RECORDING MEDIUM STORING MACHINE LEARNING PROGRAM, AND INFORMATION PROCESSING APPARATUS

(71) Applicant: Fujitsu Limited, Kawasaki-shi (JP)

(72) Inventor: Hiroaki KINGETSU, Kawasaki (JP)

(73) Assignee: Fujitsu Limited, Kawasaki-shi (JP)

(21) Appl. No.: 18/351,791

(22) Filed: Jul. 13, 2023

(30) Foreign Application Priority Data
Nov. 2, 2022 (JP) 2022-176403

(51) Int. Cl. G06N 3/0464; G06N 3/0895

(52) U.S. Cl. CPC G06N 3/0464; G06N 3/0895

(57) ABSTRACT

A recording medium stores a program for causing a computer to execute a process including: classifying data into classes based on a density of the data; performing data augmentation on first data that is positioned in a region where data which is positioned in a region of a first class and which belongs to the first class exists at a higher density than a predetermined density and on second data that is positioned in a region where the data which is positioned in the region of the first class and which belongs to the first class exists at a lower density than the predetermined density; and setting, when the first data after the data augmentation and the second data after the data augmentation overlap each other, a label that corresponds to the first class to first augmentation data, the second data, or second augmentation data.

### CROSS-REFERENCE TO RELATED APPLICATION

This application is based upon and claims the benefit of priority of the prior Japanese Patent Application No. 2022-176403, filed on Nov. 2, 2022, the entire contents of which are incorporated herein by reference.

### FIELD

The embodiment discussed herein is related to a computer-readable recording medium storing a machine learning program and the like.

### BACKGROUND

A machine learning model that performs, for example, identification and classification of data is used. In operation of the machine learning model, a “concept drift” may occur in which distribution, characteristics, and the like of data gradually differ over time from those of training data with a ground truth used for machine learning. The machine learning model performs the identification and the classification in accordance with the training data. Thus, when a tendency (data distribution) of input data changes during the operation due to the concept drift, accuracy degrades.

Japanese Laid-open Patent Publication Nos. 2020-52783 and 2013-246478 are disclosed as related art.

### SUMMARY

According to an aspect of the embodiments, a non-transitory computer-readable recording medium stores a machine learning program for causing a computer to execute a process including: classifying data into a plurality of classes based on a density of the data in a projective space to which source data is projected; performing data augmentation on first data that is positioned in a region, in the projective space, where data which is positioned in a region of a first class and which belongs to the first class exists at a higher density than a predetermined density and on second data that is positioned in a region, in the projective space, where the data which is positioned in the region of the first class and which belongs to the first class exists at a lower density than the predetermined density; and setting, in a case where the first data after the data augmentation and the second data after the data augmentation overlap each other in the projective space, a label that corresponds to the first class to first augmentation data obtained by performing the data augmentation on the first data, the second data, or second augmentation data obtained by performing the data augmentation on the second piece of the data, or arbitrary combination thereof.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining a machine learning model according to Embodiment 1;

FIG. 2 is a diagram explaining monitoring of output results of the machine learning model;

FIG. 3 is a diagram explaining a concept drift;

FIG. 4 is a diagram explaining an automatic recovery technique;

FIG. 5 is a diagram explaining an example of a data distribution;

FIG. 6 is a diagram explaining an example of data augmentation;

FIG. 7 is a diagram explaining propagation of a label;

FIG. 8 is a functional block diagram illustrating a functional configuration of an information processing apparatus according to Embodiment 1;

FIG. 9 is a diagram illustrating an example of training data stored in a training database (DB);

FIG. 10 is a diagram illustrating an example of information stored in an output result DB;

FIG. 11 is a diagram illustrating an example of the training data stored in the training DB;

FIG. 12 is a flowchart illustrating a flow of an automatic recovery process according to Embodiment 1;

FIG. 13 is a schematic diagram illustrating an example of change in operation data;

FIG. 14 is a diagram explaining an aspect of an effect; and

FIG. 15 is a diagram explaining a hardware configuration example.

### DESCRIPTION OF EMBODIMENTS

As one of techniques to address such a concept drift, an automatic recovery technique has been proposed. The automatic recovery technique causes recovery from the accuracy degradation of the machine learning model to be automatically performed in accordance with operation data input at the time of operation. For example, the operation data input at the time of the operation is represented in a data space. The operation data represented in the data space is separated at a boundary line called a decision boundary by the machine learning model. Next, the operation data represented in the data space is projected to a feature space that is a mathematical space in which the feature of the data distribution is represented as a data group. Density-based clustering is executed for the operation data projected to the feature space as described above. Thus, out of data groups formed with the operation data belonging to the same class as the class output by the machine learning model, a set of the operation data positioned in a high density region where the operation data is dense is extracted as a cluster. The set of the operation data extracted as the cluster is set as a retraining data set, and a class corresponding to the cluster is assigned to individual pieces of the operation data as a pseudo ground truth. When retraining is executed by using the retraining data set to which the pseudo label is assigned as described above, the automatic recovery from the accuracy degradation of the machine learning model is realized while setting operation of the ground truth is not desired.

However, with the above-described automatic recovery technique, in a case where a high density region of a cluster used for retraining of a machine learning model is small, the number of pieces of retraining data is insufficient. Thus, it is difficult to suppress the accuracy degradation of the machine learning model.

In one aspect, an object is to be provided a machine learning program, a method for machine learning, and an information processing apparatus that may suppress accuracy degradation of a machine learning model.

Hereinafter, an embodiment of a machine learning program, a method for machine learning, and an information processing apparatus according to the present disclosure will be described in detail with reference to the drawings. The disclosure is not limited by the embodiment. Portions of the embodiment may be appropriately combined with each other as long as they do not contradict each other.

### Embodiment 1

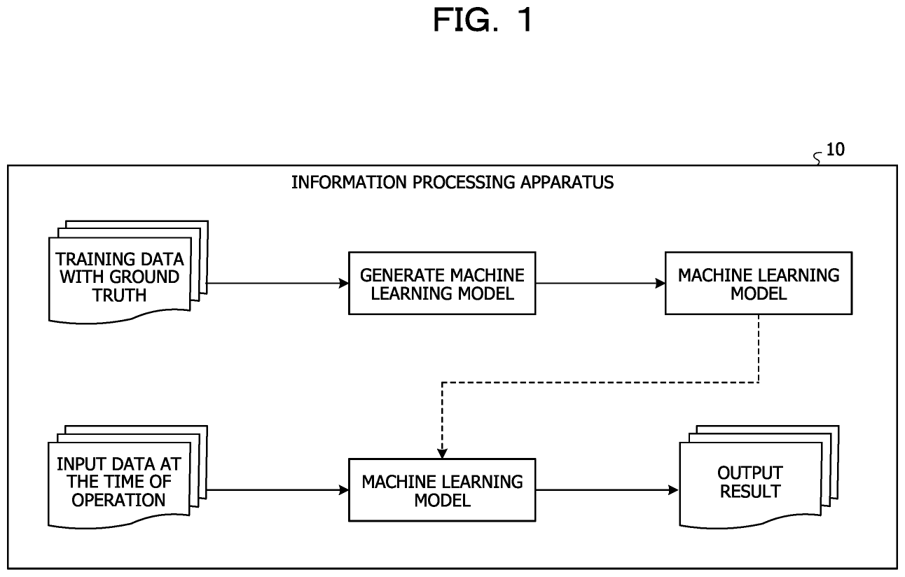

FIG. 1 is a diagram explaining a machine learning model according to Embodiment 1. As illustrated in FIG. 1, in a training phase, an information processing apparatus 10 trains a machine learning model through machine learning using training data with a ground truth. In an operation phase, the information processing apparatus 10 uses the trained machine learning model to execute multi-class classification, two-class classification, or the like on operation data input at the time of operation. Examples of a task of such a machine learning model include image recognition that recognizes an object such as a person or a thing captured in image data.

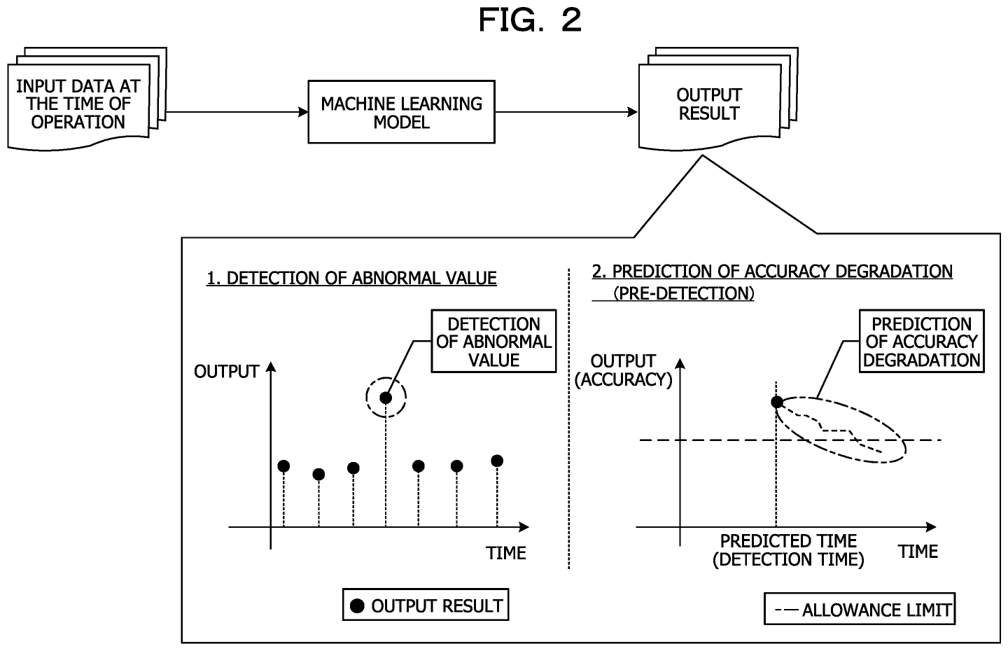

After introduction of the machine learning model, accuracy of the machine learning model may degrade over time. Thus, output results may be monitored in some cases. FIG. 2 is a diagram explaining monitoring of the output results of the machine learning model. As illustrated in FIG. 2, an administrator or the like monitors the output results output by the machine learning model in accordance with operation data input at the time of operation. At this time, the administrator or the like detects an abnormal value different from a normal value by monitoring and determines that retraining of the machine learning model is desired in a case where, for example, the abnormal value is generated a predetermined number of times. The administrator or the like predicts accuracy degradation by monitoring and determines that retraining of the machine learning model is desired in a case where it is determined that the accuracy falls below an allowable accuracy.

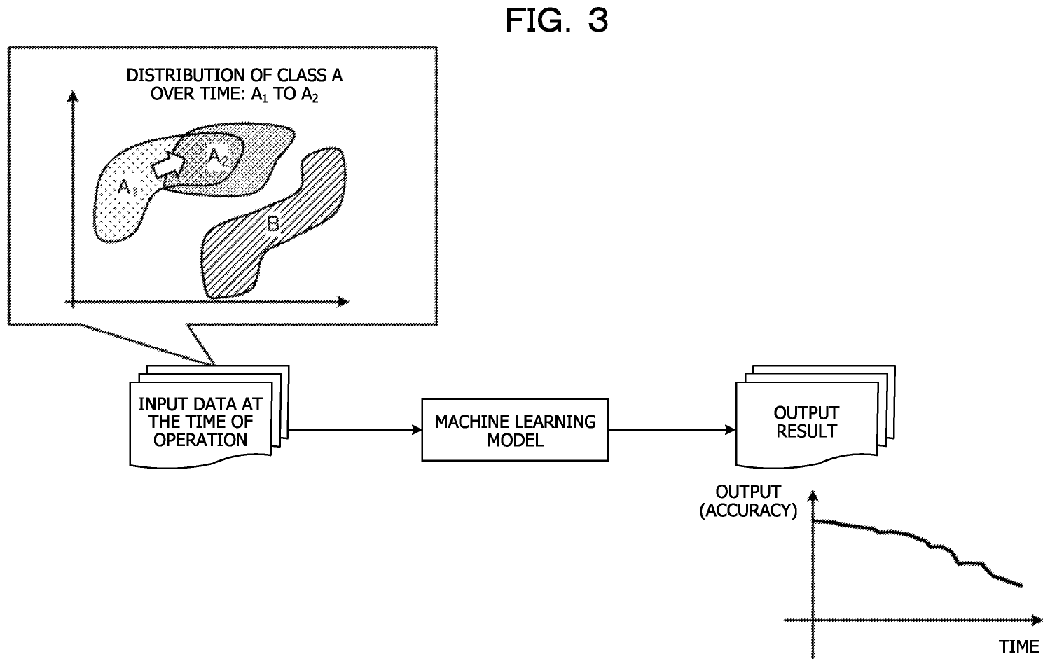

One of factors of the accuracy degradation of the machine learning model over time is a concept drift in which a distribution of data changes. FIG. 3 is a diagram explaining the concept drift. As illustrated in FIG. 3, a distribution of class A changes from A₁ to A₂ over time. In this case, since the machine learning model executes the machine learning based on class A₁, the machine learning model does not necessarily correctly identify class A₂ as class A even when data of class A2 is input. Examples of changes in data distribution due to the concept drift include, for example, spam that changes so as not to be filtered by a spam filter, demand for electricity, stock prices, and image data that depends on an imaging environment changing, for example, from summer to winter and from morning to night.

As one of techniques to address such a concept drift, an automatic recovery technique has been proposed. The automatic recovery technique causes recovery from the accuracy degradation of the machine learning model to be automatically performed in accordance with operation data input at the time of operation.

For example, the operation data input at the time of the operation is represented in a data space. The operation data represented in the data space is separated at a boundary line called a decision boundary by the machine learning model. Next, the operation data represented in the data space is projected to a feature space that is a mathematical space in which the feature of the data distribution is represented as a data group. Density-based clustering is executed for the operation data projected to the feature space as described above. Thus, out of data groups formed with the operation data belonging to the same class as the class output by the machine learning model, a set of the operation data positioned in a high density region where the operation data is dense is extracted as a cluster. The set of the operation data extracted as the cluster is set as a retraining data set, and a class corresponding to the cluster is assigned to individual pieces of the operation data as a pseudo ground truth. When retraining is executed by using the retraining data set to which the pseudo label is assigned as described above, the automatic recovery from the accuracy degradation of the machine learning model is realized while setting operation of the ground truth is not desired.

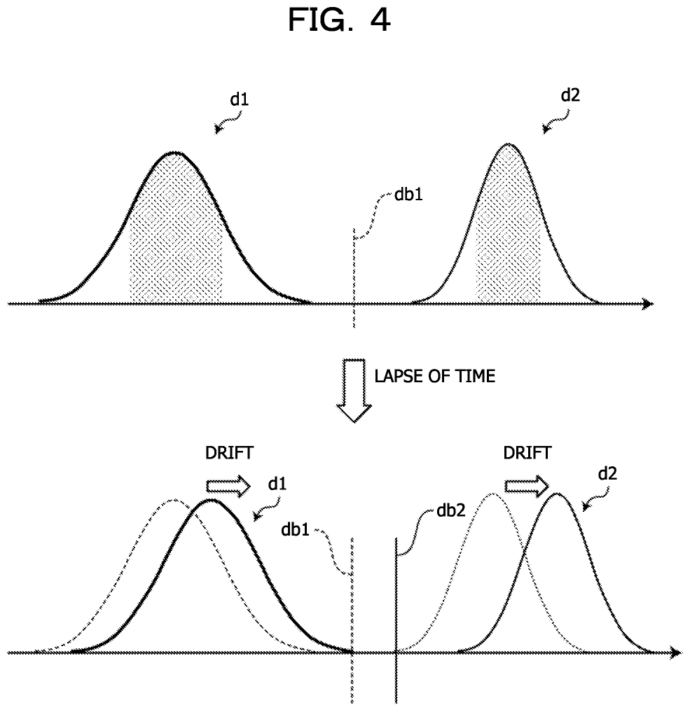

FIG. 4 is a diagram explaining the automatic recovery technique. FIG. 4 illustrates a histogram related to the operation data projected to the feature space. In the histogram illustrated in FIG. 4, a single feature obtained by dimensionally reducing a plurality of features representing the feature space is indicated as the horizontal axis and the density is indicated as the vertical axis.

For example, referring to an example illustrated in FIG. 4, the histogram includes two distributions, which are a distribution d1 of the operation data corresponding to class A and a distribution d2 of the operation data corresponding to class B.

Although the distribution d1 and the distribution d2 are separated at a decision boundary db1 obtained by the training of the machine learning model, as described above, the distribution d1 and the distribution d2 change due to a lapse of time from the time of the training of the machine learning model. For example, as illustrated in FIG. 4, in a case where the distribution d1 and the distribution d2 each drift rightward, for example, in the positive direction, the distribution d1 approaches the decision boundary db1 and the distribution d2 moves away from the decision boundary db1. In a case where such a concept drift is unattended, the distribution d1 exceeds the decision boundary db1, and thereby classification accuracy of the machine learning model degrades.

For this reason, in the above-described automatic recovery technique, the decision boundary of the machine learning model is updated from db1 to db2 by executing retraining of the machine learning model before the distribution d1 exceeds the decision boundary db1.

In the above-described automatic recovery technique, out of the cluster that is the data group of the operation data projected to the feature space, the operation data positioned in the high density region is used for the retraining of the machine learning model. The reason for this is that whether the class output by the machine learning model is correct becomes uncertain due to the operation data that is far from the peak of the distribution and closer to the edge of the distribution.

In FIG. 4, out of the distribution d1 and the distribution d2 corresponding to the respective classes, regions in which the density of the operation data is a high density including the peak are indicated as dotted regions. The operation data positioned in these high density regions may be cut out as clusters by applying density-based clustering to the operation data projected to the feature space.

The operation data positioned in the high density regions extracted as described above is extracted as the retraining data. In an aspect of automatization of label setting, labels corresponding to the classes of the respective clusters are assigned to the retraining data as pseudo ground truths. The retraining is executed by using the retraining data to which the pseudo labels are assigned as described above.

However, with the above-described automatic recovery technique, in a case where the high density region of the cluster used for retraining of the machine learning model is small, the number of pieces of retraining data is insufficient. Thus, there is an aspect in which suppression of the accuracy degradation of the machine learning model is difficult.

For example, the degree of an effect of suppressing the accuracy degradation of the machine learning model by applying the above-described automatic recovery technique depends on the distribution of data, and in some cases, the operation data of the individual classes is not necessarily sufficiently separated in the feature space by the density-based clustering depending on the distribution of data.

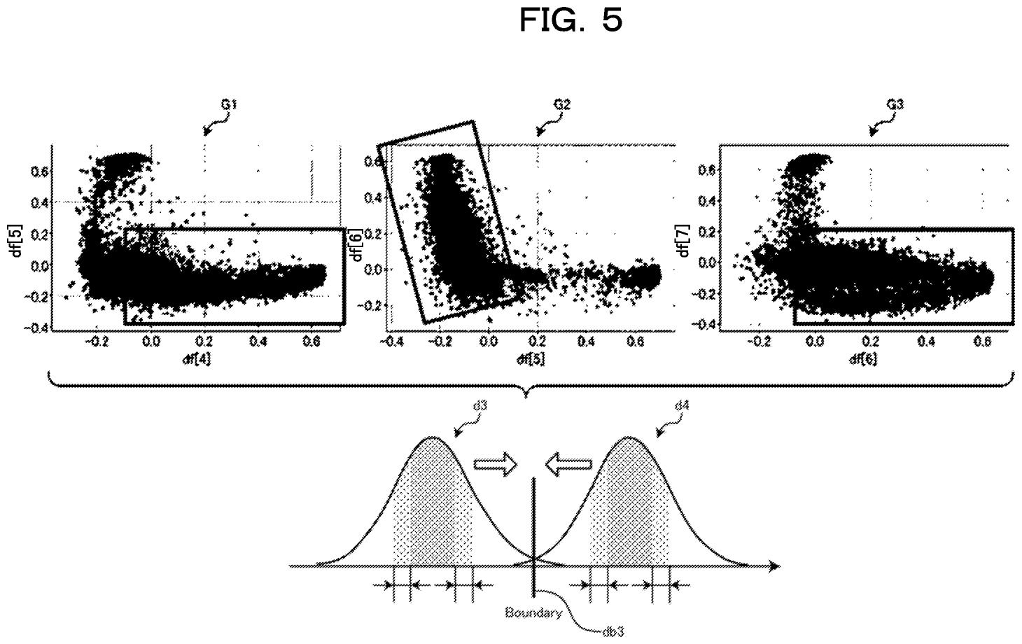

FIG. 5 is a diagram explaining an example of the data distribution. FIG. 5 illustrates examples of three graphs G1 to G3 indicating data distributions in the feature space dimensionally reduced to two dimensions. FIG. 5 illustrates, as an example of graphs G1 to G3, a data distribution in a case where an image data set of the Fashion-Modified National Institute of Standards and Technology (MNIST) is projected to the feature space.

For example, regarding an example of the Fashion-MNIST, out of 10 types of classes including class 0 to class 9, the distance between pieces of the image data in class 2 and class 4 or class 7 and class 9 is small, and accordingly, data distributions become those illustrated in the graphs G1 to G3 of FIG. 5. According to these graphs G1 to G3, it is clear that the image data of different classes is distributed at high density in a region surrounded by a rectangle and the positions of the image data overlap each other between the different classes.

In this case, a peripheral portion of a density peak in the data distribution may approach or overlap the decision boundary of the machine learning model. For example, FIG. 5 schematically illustrates a distribution d3 and a distribution d4 corresponding to two classes as an example of a histogram of the image data set of the Fashion-MNIST projected to the feature space.

In an aspect, as density peaks of the distribution d3 and the distribution d4 move closer to a decision boundary db3 of the machine learning model, densities to be extracted as clusters by the density-based clustering unavoidably increase.

The reason for this is that the density-based clustering is an algorithm that is established under an assumption that the density peak has a unimodal characteristic. For example, in a case where the density-based clustering is executed under the setting of the density at which the clusters are not sufficiently separated, all the clusters are adversely affected, and accuracy of the clustering degrades. For this reason, to extract sufficiently separated clusters, the density to be extracted as a cluster in the density-based clustering is unavoidably set to a higher density, and the scale of the high density region extracted as a cluster unavoidably reduces.

The density-based clustering is the algorithm established also under an assumption that the cluster-by-cluster densities are approximately the same, for example, not unbalanced. For this reason, in a case where the density to be extracted as a cluster is set to be higher in the density-based clustering, all the clusters, for example, all the high density regions are extracted on an equal scale. For this reason, although there is room for extracting a cluster having a larger scale for a data distribution of a class the density peak of which is sufficiently separated from the decision boundary, only a cluster having a small scale may be extracted as in the other classes.

As has been described, in the above-described automatic recovery technique, as the set value of the density to be extracted as the cluster in the density-based clustering increases, the scale of the cluster used for retraining the machine learning model reduces. Thus, the number of pieces of retraining data is insufficient. Consequently, according to the above-described automatic recovery technique, it is difficult to suppress the accuracy degradation of the machine learning model.

Accordingly, the information processing apparatus 10 according to Embodiment 1 applies data augmentation to both a portion where the operation data is dense and a portion where the operation data is not dense and provides a function of propagating a label of a cluster to operation/augmentation data that is outside the cluster and sufficiently close to the cluster in a projective space.

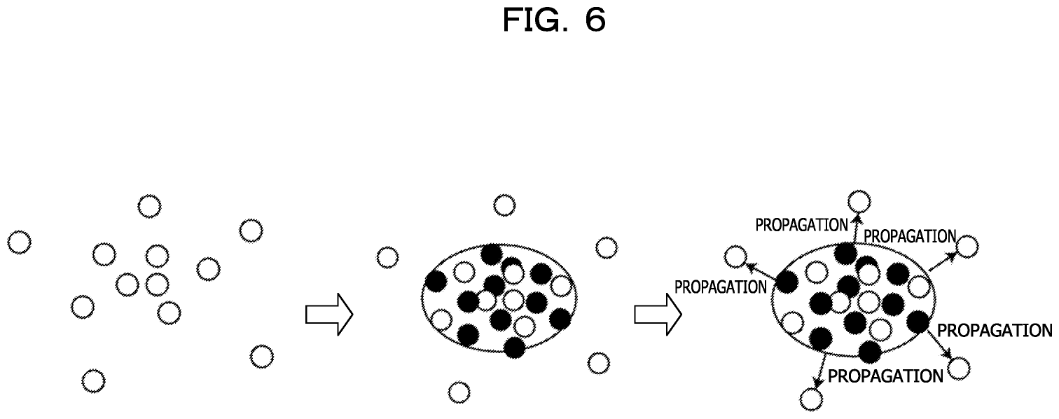

FIG. 6 is a diagram explaining an example of the data augmentation. FIG. 6 illustrates operation data having undergone the concept drift, for example, input data for which the machine learning model is unknown with empty circles and augmentation data obtained by augmenting the input data with solid circles.

As illustrated in FIG. 6, the data augmentation is applied to a set of operation data having undergone the concept drift. Such data augmentation may be realized by a technique that processes source data by giving a fine change to source data and adds the processed data, as other data, to a data set, for example, test time augmentation (TTA). Accordingly, a high density region in which the density of the operation data is high and which is a portion surrounded by a broken line in the drawing is artificially generated. As a result, the scale of the cluster obtained by the density-based clustering may be increased. After that, the label of the class corresponding to the cluster obtained by the density-based clustering is propagated to its neighboring data (noise).

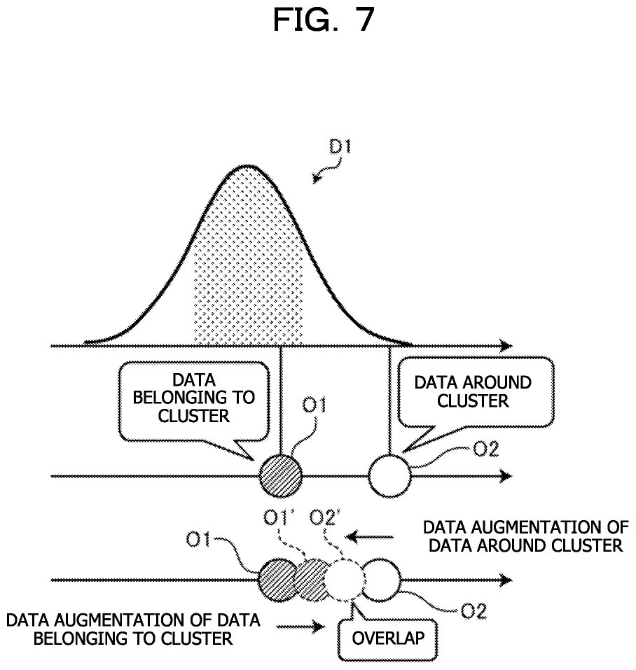

FIG. 7 is a diagram explaining the propagation of the label. FIG. 7 illustrates an extraction of a distribution D1 of the operation data belonging to a certain class as an example of a histogram of the operation data projected to the feature space. FIG. 7 also illustrates, as a dotted region, the high density region corresponding to the cluster extracted by the density-based clustering out of the distribution D1. Furthermore, FIG. 7 schematically illustrates, with a hatched circle, operation data O1 extracted from the operation data belonging to the cluster and illustrates, with a circle without hatching, operation data O2 extracted from the operation data around the cluster.

As illustrated in FIG. 7, the TTA is applied to both the operation data O1 belonging to the cluster and the operation data O2 around the cluster. Consequently, augmentation data O1′ is obtained from the operation data O1, and augmentation data O2′ is obtained from the operation data set O2. In a case where the augmentation data O2′ overlaps the augmentation data O1′, the label of the cluster is propagated to the operation data O2 and the augmentation data O2′. Although an example in which the label is propagated in the case where the augmentation data O2′ overlaps the augmentation data O1′ has been illustrated in FIG. 7, in addition to that, the label of the cluster may be propagated also in a case where the augmentation data O2′ overlaps the operation data O1 and in a case where the augmentation data O1′ overlaps the operation data O2. As a result of such label propagation, the number of pieces of training data used for the retraining of machine learning data may be increased.

Accordingly, with the information processing apparatus 10 according to Embodiment 1, the accuracy degradation of the machine learning model may be suppressed.

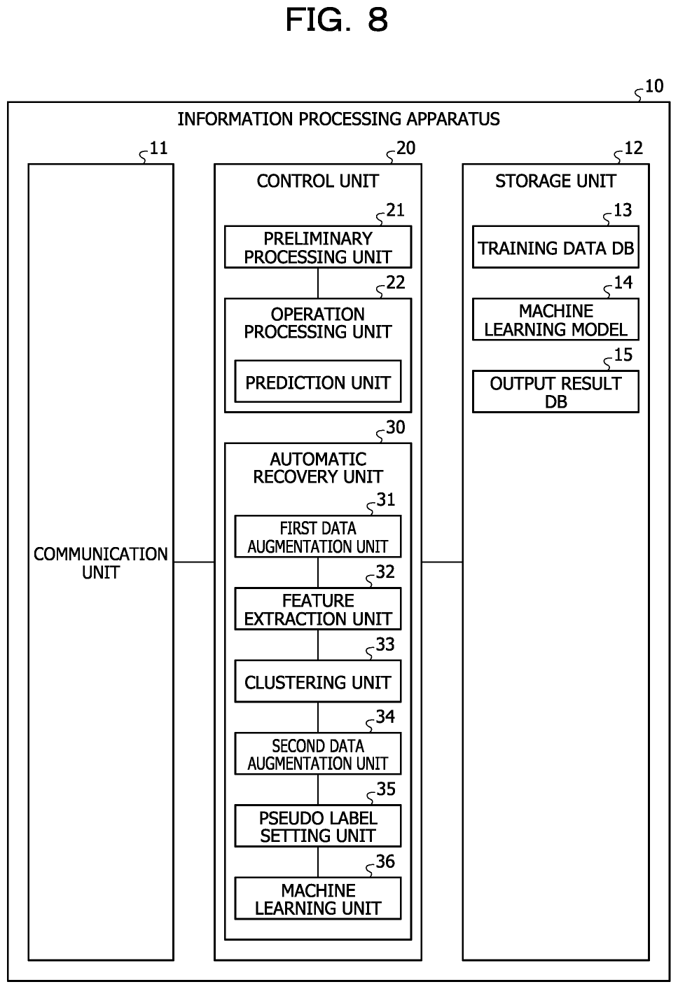

FIG. 8 is a functional block diagram illustrating a functional configuration of the information processing apparatus 10 according to Embodiment 1. As illustrated in FIG. 8, the information processing apparatus 10 includes a communication unit 11, a storage unit 12, and a control unit 20.

The communication unit 11 controls communication with other devices. For example, the communication unit 11 receives the operation data to be predicted by the machine learning model from various external devices such as a sensor, a camera, a server, and an administrator terminal.

The storage unit 12 stores various types of data, a program to be executed by the control unit 20, and so forth. For example, the storage unit 12 stores a training database (DB) 13, a machine learning model 14, and an output result DB 15.

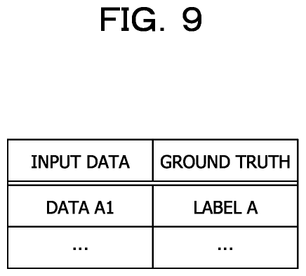

The training DB 13 stores a data set of the training data used for the machine learning of the machine learning model 14. FIG. 9 is a diagram illustrating an example of the training data stored in the training DB 13. As illustrated in FIG. 9, each piece of training data stored in the training DB 13 has “INPUT DATA, GROUND TRUTH”.

Here, “INPUT DATA” is an explanatory variable of the machine learning and is, for example, image data, and “GROUND TRUTH” is an objective variable of the machine learning, and is, for example, a subject appearing in image data, for example, a person or the like that is a specific object. In the example of FIG. 9, training data in which data A1 is associated with a label A is illustrated. For example, in a case where the machine learning model 14 for image classification or the like is generated, the training DB 13 stores, as the training data, image data to which a ground truth “dog” is assigned, image data to which a ground truth “cat” is assigned, and the like.

The machine learning model 14 is a model generated by machine learning. For example, the machine learning model 14 is a model using a deep neural network (DNN) or the like and may be an other machine learning algorithm such as a neural network or a support vector machine. For example, in a case where the task of the machine learning model 14 is an image recognition task, it may be realized by a model having a feature extraction layer such as a convolutional neural network (CNN) and a fully connected layer that constructs the decision boundary. Although an example is described in which the machine learning model 14 is generated by a control unit, which will be described later, according to the present embodiment, the machine learning model 14 may be generated by an other device.

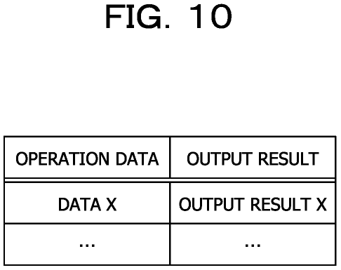

The output result DB 15 stores output results obtained by operation of the machine learning model 14. For example, the output result DB 15 stores prediction results predicted by the machine learning model 14 such as class-by-class certainty factors or a label of a class with the highest certainty factor. FIG. 10 is a diagram illustrating an example of information stored in the output result DB 15. As illustrated in FIG. 10, the output result DB 15 stores “OPERATION DATA, OUTPUT RESULT” such that the “OPERATION DATA, OUTPUT RESULT” are associated with each other. The “OPERATION DATA” is data to be predicted input to the machine learning model 14. The “OUTPUT RESULT” is a prediction result predicted by the machine learning model 14. In the example illustrated in FIG. 10, data X is input to the machine learning model 14 and an output result X is obtained.

The control unit 20 is a processing unit that controls the entirety of the information processing apparatus 10. For example, the control unit 20 includes a preliminary processing unit 21, an operation processing unit 22, and an automatic recovery unit 30.

As preliminary processing before the operation of the machine learning model 14, the preliminary processing unit 21 generates the machine learning model 14. For example, the preliminary processing unit 21 updates various types of parameters of the machine learning model 14 through machine learning using pieces of training data stored in the training DB 13, thereby to generate the machine learning model 14.

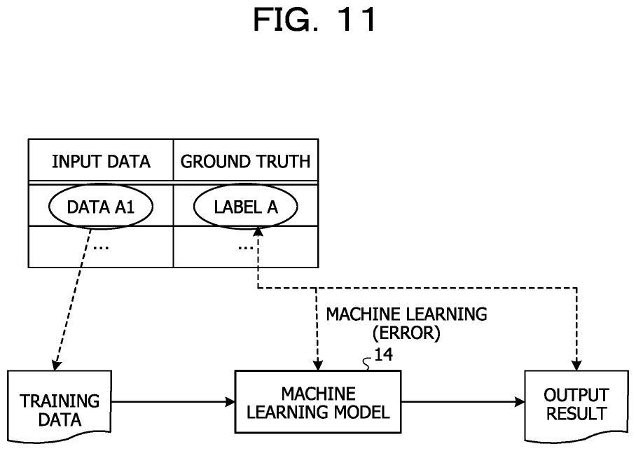

FIG. 11 is a diagram illustrating an example of the training data stored in the training DB. As illustrated in FIG. 11, the preliminary processing unit 21 inputs the training data “DATA A1, LABEL A1” of the training DB 13 to the machine learning model 14 and executes the machine learning of the machine learning model 14 such that an error between the output result of the machine learning model 14 and the ground truth “LABEL A” reduces.

The operation processing unit 22 includes a prediction unit 23 and executes prediction by using the machine learning model 14. The prediction unit 23 executes the prediction using the generated machine learning model 14. For example, upon receiving operation data X to be predicted, the prediction unit 23 inputs the operation data X to the machine learning model 14 and obtains output result X. The prediction unit 23 stores the “OPERATION DATA X” and the “OUTPUT RESULT X” in the output result DB 15 such that the “OPERATION DATA X” and the “OUTPUT RESULT X” are associated with each other.

The automatic recovery unit 30 is a processing unit that causes recovery from the accuracy degradation of the machine learning model 14 to be automatically performed in accordance with the operation data input at the time of operation. The automatic recovery unit 30 includes a first data augmentation unit 31, a feature extraction unit 32, a clustering unit 33, a second data augmentation unit 34, a pseudo label setting unit 35, and a machine learning unit 36.

The first data augmentation unit 31 is a processing unit that augments the operation data. For example, the first data augmentation unit 31 obtains the operation data stored in the output result DB 15 and applies the data augmentation to each piece of the operation data. Such data augmentation may be realized by a technique that processes source data by giving a fine change to the source data and adds the processed data, as other data, to the data set, for example, the TTA. Examples of the fine processing executed here include flipping (inversion), Gaussian noise, enlargement, reduction, and the like. The operation data is augmented by at least one type of the processing or combination of two or more types of the processing. Of course, at this time, the type of the processing may be adaptively selected in accordance with the type of data input to the machine learning model 14. For example, in a case where the image data input to the machine learning model 14 is numerical data of the MNIST or the like, density peaks of data distributions of a numeric character “6” of a class 6 and a numeric character “9” of a class 9 out of 10 types of classes overlap each other, and accordingly, flipping may be excluded.

With such data augmentation, a high density region in which the density of the operation data is high, for example, the portion surrounded by a broken line in FIG. 6, is artificially generated. As a result, the scale of the cluster obtained by the density-based clustering may be increased.

Hereinafter, from an aspect of distinguishing the label of the operation data stored in the output result DB 15 from the label of the data obtained by the augmentation from the operation data by the first data augmentation unit 31, the former may be referred to as “original data” and the latter may be referred to as “first augmentation data”. When it is not desired that the original data and the first augmentation data be distinguished from each other, the data is referred to as “operation data A”.

The feature extraction unit 32 is a processing unit that executes feature extraction and projective transformation into the feature space of the operation data A augmented by the first data augmentation unit 31. In one aspect, such feature extraction and projective transformation may be realized by a machine learning model 32A different from the machine learning model 14.

For example, the machine learning model 32A includes a feature extraction layer having the same layer structure as that of the feature extraction layer included in the machine learning model 14 and a distance learning layer that embeds feature vectors output from the feature extraction layer into a hyperspherical feature space.

The machine learning model 32A may be trained when so-called distance metric learning is executed by using the data set of the training data stored in the training DB 13. For example, in the distance metric learning, transformation that causes similarity between training samples in an input space to correspond to a distance in a feature space is trained. For example, in the distance metric learning, an original space is distorted such that the distance between the training samples belonging to the same class is small and the distance between the training samples belonging to different classes is large. The “feature space” corresponds to an example of a projective space and, in some cases, may also be referred to as a metric space or an embedding space.

The machine learning model 32A trained as described above is used for the feature extraction and the projective transformation into the feature space of the operation data A. For example, the feature extraction unit 32 inputs, to the machine learning model 32A, both the original data and the operation data A including the first augmentation data obtained by the data augmentation by using the first data augmentation unit 31 so as to obtain an embedding vector output by the machine learning model 32A for each piece of the operation data A. Thus, the feature extraction and the projective transformation into the feature space of the operation data A are realized.

The clustering unit 33 is a processing unit that clusters features of the operation data A. For example, the clustering unit 33 applies the density-based clustering to a set of the operation data A based on the embedding vector obtained for each piece of the operation data by the feature extraction unit 32. Thus, out of data groups formed with the operation data A belonging to the same class as an output result of the machine learning model 14, a set of the operation data A positioned in a high density region where the operation data A is dense is extracted as a cluster.

The second data augmentation unit 34 is a processing unit that augments the operation data not belonging to the cluster obtained as the result of clustering by the clustering unit 33. For example, the second data augmentation unit 34 applies the data augmentation to the operation data not belonging to the cluster obtained as the result of the clustering by the clustering unit 33 out of the set of the operation data A. Although an example in which the second data augmentation unit 34 augments each piece of the operation data not belonging to the cluster is described herein, the data augmentation may be executed by narrowing the target of the augmentation to the operation data around the cluster, for example, to the neighboring data outside the cluster.

Hereinafter, in the case of distinguishing the label of the operation data not belonging to the cluster from the label of the data obtained by the augmentation from the operation data not belonging to the cluster by the second data augmentation unit 34, the data obtained by the augmentation from the operation data not belonging to the cluster may be referred to as “second augmentation data” in some cases.

The pseudo label setting unit 35 is a processing unit that sets a pseudo ground truth for retraining of the machine learning model 14. In one aspect, the pseudo label setting unit 35 assigns, to the operation data belonging to the cluster obtained as a result of the clustering by the clustering unit 33, a pseudo label B of a class corresponding to the cluster. Both the original data and the first augmentation data may be included in the operation data to which such a pseudo label B is assigned. In an other aspect, the pseudo label setting unit 35 assigns, to operation data positioned at a distance smaller than or equal to a threshold from the operation data belonging to the cluster out of the operation data not belonging to the cluster, a pseudo label C of a class corresponding to the cluster. In this case, in a case where the operation data not belonging to the cluster is the second augmentation data, the pseudo label C is also assigned to the operation data that is the source of the second augmentation data. All of the original data, the first augmentation data, and the second augmentation data may be included in the operation data to which such a pseudo label C is assigned.

The machine learning unit 36 is a processing unit that retrains the machine learning model 14. For example, the machine learning unit 36 sets, as a retraining data set, a set of operation data to which the pseudo label B and the pseudo label C are assigned by the pseudo label setting unit 35 and retrains the machine learning model 14 by using the retraining data set. For example, the machine learning unit 36 back propagates to the machine learning model 14 a loss, for example, a cross entropy error, calculated from the pseudo label and output of the machine learning model 14 to which the retraining data included in the retraining data set is input. Thus, the parameters such as the weight and the bias of the machine learning model 14 are retrained.

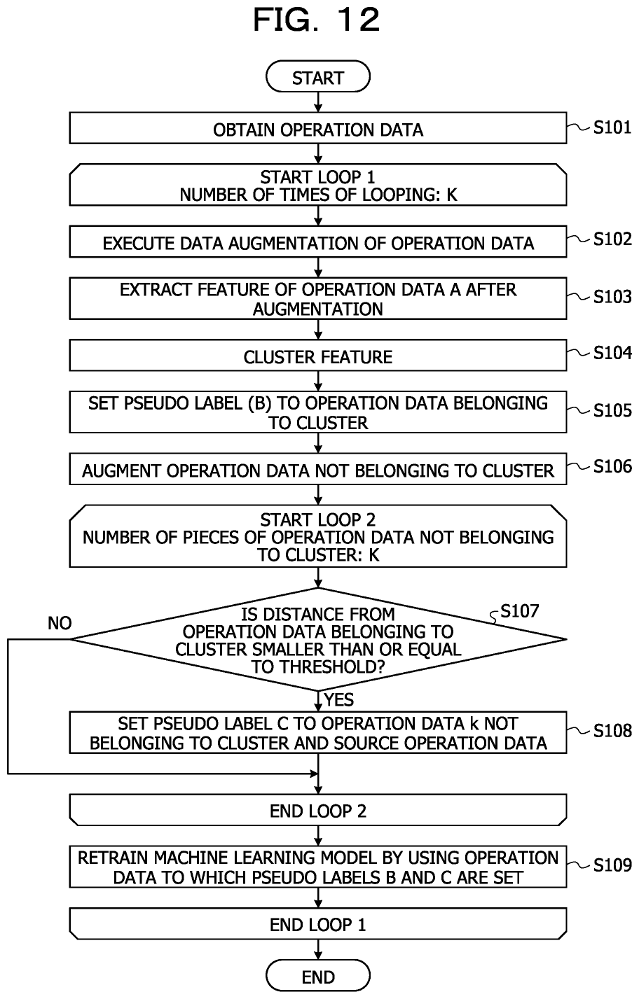

FIG. 12 is a flowchart illustrating a flow of an automatic recovery process according to Embodiment 1. Although FIG. 12 illustrates an example in which the epochs of retraining of the machine learning model 14 are set based on the number of loops, the epochs may be set based on another convergence condition for parameter update, for example, a learning rate.

As illustrated in FIG. 12, the first data augmentation unit 31 obtains the operation data stored in the output result DB 15 (S101). Next, a loop process 1 in which processing from step S102 to step S109 below is repeated until the number of times of looping reaches a specified number of times L is executed.

For example, the first data augmentation unit 31 applies the data augmentation to the operation data obtained in step S101 (S102). Next, the feature extraction unit 32 inputs, to the machine learning model 32A, both the original data obtained in step S101 and the operation data A including the first augmentation data obtained through the data augmentation in step S102 so as to obtain an embedding vector output by the machine learning model 32A for each piece of the operation data A (S103). Thus, the feature extraction and the projective transformation into the feature space of the operation data A are realized.

The clustering unit 33 applies the density-based clustering to a set of the operation data A based on the embedding vector obtained for each piece of the operation data in step S103 (S104).

After that, the pseudo label setting unit 35 assigns, to the operation data belonging to the cluster obtained as a result of the clustering in step S104, the pseudo label B of a class corresponding to the cluster (S105).

Next, the second data augmentation unit 34 applies the data augmentation to the operation data not belonging to the cluster obtained as the result of the clustering in step S104 out of the set of the operation data A (S106).

A loop process 2, in which processing in step S107 and step S108 below is repeated as many times corresponding to a number K of pieces of the operation data not belonging to the cluster obtained as the result of clustering in step S104, is executed. Although an example in which the processing of step S107 and step S108 are repeated is to be described, the processing of step S107 and step S108 may be executed in parallel.

For example, the pseudo label setting unit 35 determines whether the distance between operation data k not belonging to the cluster and operation data, out of the operation data belonging to the cluster, at a position separated from the operation data k by a smallest distance is smaller than or equal to a threshold (S107).

In a case where the distance is smaller than or equal to the threshold (S107: Yes), the pseudo label setting unit 35 assigns the pseudo label C of the class corresponding to the cluster to the operation data k not belonging to the cluster (S108). In a case where the operation data k not belonging to the cluster is the second augmentation data, the pseudo label C may also be assigned to the operation data that is the source of the second augmentation data.

When such a loop process 2 is repeated, the label of the cluster is propagated to the operation data that is around the cluster out of the operation data k not belonging to the cluster and that is sufficiently close to the operation data belonging to the cluster in the feature space through the data augmentation by the second data augmentation unit 34.

The machine learning unit 36 sets, as a retraining data set, a set of the operation data to which the pseudo label B is assigned in step S105 and the operation data to which the pseudo label C is assigned in step S108 and retrains the machine learning model 14 by using the retraining data set (S109).

Repeating such a loop process 1 realizes the retraining that causes the parameters of the machine learning model 14 to converge to parameters with which input data may be classified at the decision boundary corresponding to the drift of the distribution of the operation data stored in the output result DB 15.

As described above, the information processing apparatus 10 according to Embodiment 1 applies data augmentation to both a portion where the operation data is dense and a portion where the operation data is not dense and provides the function of propagating a label of a cluster to the operation/augmentation data that is outside the cluster and sufficiently close to the cluster in the projective space. As a result of such label propagation, the number of pieces of training data used for the retraining of machine learning data may be increased. Accordingly, with the information processing apparatus 10 according to Embodiment 1, the accuracy degradation of the machine learning model may be suppressed.

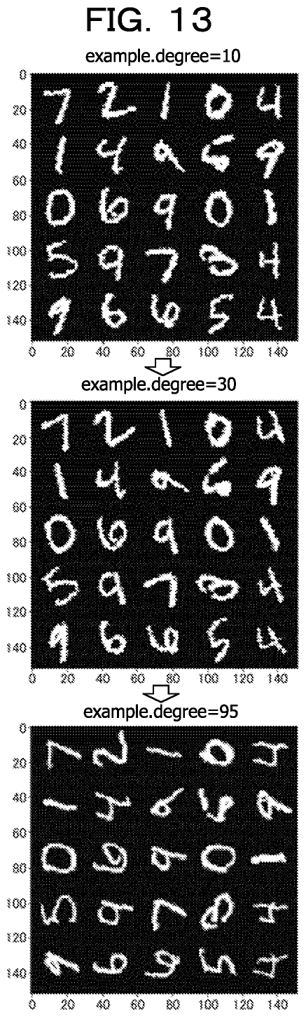

Here, a result of verifying the accuracy degradation with respect to the machine learning model 14 retrained by using the retraining data set with a pseudo label is described. For such verification, to exemplify a change in the operation data in which the concept drift occurs, a case where retraining is performed in accordance with the change in the operation data illustrated in FIG. 13 is described as an example.

FIG. 13 is a schematic diagram illustrating the example of the change in the operation data. FIG. 13 exemplifies image recognition of handwritten numeric characters as an example of a task of the machine learning model 14 and illustrates examples in which each of 10000 pieces of image data included in the MNIST is rotated by a specific angle, for example, five degrees every time a certain period of time elapses as an example of the change in the operation data. Such rotation corresponds to the change in operation data corresponding to rotation of the camera. Since 10 types of classes from class 0 to class 9 exist in the MNIST, 1000 pieces of image data are obtained as examples of the operation data per class. For example, FIG. 13 schematically illustrates how to rotate each of 10000 pieces of the image data included in the MNIST, illustrating, from the top, extracted examples of 10-degree rotation, 30-degree rotation, and 95-degree rotation of individual pieces of the image data.

Although FIG. 13 exemplifies the rotation of the camera as an example of the change in the operation data, this is not limiting. For example, as an example of the change in the operation data, in a case where a camera is scratched, Gaussian noise may be added to the image data by using a Gaussian filter or the like.

For such operation data, the automatic recovery unit 30 according to Embodiment 1 executes the automatic recovery under the following conditions. For example, the ordering points to identify the clustering structure (OPTICS) is used as an algorithm for the density-based clustering executed by the clustering unit 33. Embedding of the machine learning model 32A used by the feature extraction unit 32 in the hyperspherical plane is realized by the AdaCos.

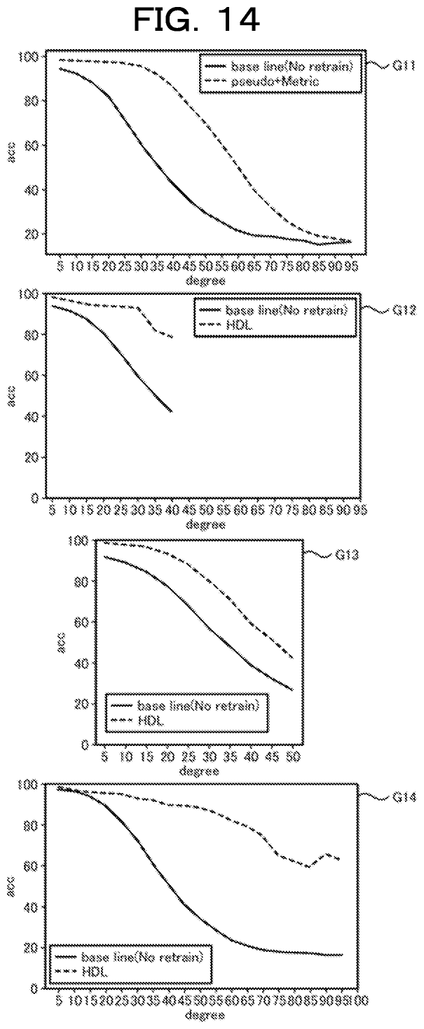

FIG. 14 is a diagram explaining an aspect of an effect. FIG. 14 illustrates four graphs from a graph G11 to a graph G14. In graphs G11 to G14 illustrated in FIG. 14, the horizontal axis indicates the angle by which the MNIST image data are rotated, and the vertical axis indicates a correct answer rate of the image recognition for the rotated image data. Also in graphs G11 to G14 illustrated in FIG. 14, the relationship between the rotation angle and the correct answer rate in a case where the retraining of the machine learning model 14 is not performed is indicated by a solid line.

For example, in graph G11 illustrated in FIG. 14, a broken line indicates the relationship between the rotation angle and the correct answer rate in a case where the retraining of the machine learning model 14 is performed by using a related-art technique called self-learning. The self-learning is a semi-supervised technique in which new data is labeled with a past learning model (=pseudo label), and the retraining is performed with the machine learning model using the pseudo label.

In graph G12 illustrated in FIG. 14, a broken line indicates the relationship between the rotation angle and the correct answer rate in a case where the retraining of the machine learning model 14 is performed by using the related-art automatic recovery technique described with reference to FIG. 4. For example, according to graph G12, it may be understood that it is impossible to follow at the rotation angle of 15 degrees to 40 degrees.

In graph G13 illustrated in FIG. 14, a broken line indicates the relationship between the rotation angle and the correct answer rate in a case where the retraining of the machine learning model 14 is performed by using the related-art automatic recovery technique described with reference to FIG. 4 and a related-art transfer learning. For example, according to graph G13, it may be understood that it is impossible to follow at the rotation angle of about 50 degrees.

In graph G14 illustrated in FIG. 14, a broken line indicates the relationship between the rotation angle and the correct answer rate in a case where the retraining of the machine learning model 14 is performed by using the automatic recovery technique according to Embodiment 1 and the related-art transfer learning. For example, according to graph G14, it may be understood that it is impossible to follow at the rotation angle of about 90 degrees.

When these graphs G11 to G14 are compared, it may be clear that the automatic recovery technique according to Embodiment 1 is desirable compared to the related-art technique called self-learning or the related-art automatic recovery technique described with reference to FIG. 4 from a multifaceted viewpoints including, for example, a range of the angle able to follow rotation and the correct answer rate at each rotation angle.

The processing procedure, the control procedure, the specific names, and the information including various types of data and parameters that are described above in the document and the drawings may be arbitrarily changed unless otherwise noted.

The specific form of distribution or integration of the elements in devices or apparatus is not limited to those illustrated in the drawings. For example, the preliminary processing unit 21, the operation processing unit 22, and the automatic recovery unit 30 may be integrated with each other. For example, all or a subset of the elements may be functionally or physically distributed or integrated in arbitrary units depending on various types of loads, usage states, or the like. All or arbitrary part of the processing functions of the apparatus may be realized by a CPU and a program analyzed and executed by the CPU or may be realized as hardware using wired logic.

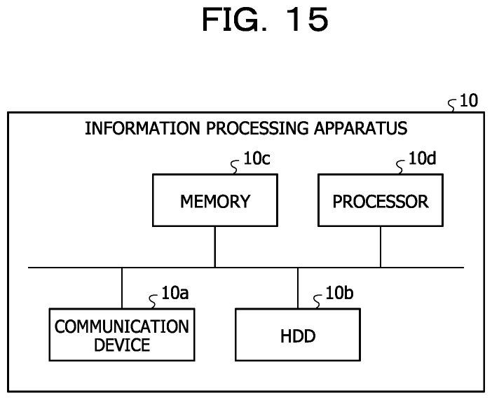

FIG. 15 is a diagram explaining a hardware configuration example. As illustrated in FIG. 15, the information processing apparatus 10 includes a communication device 10a, a hard disk drive (HDD) 10b, a memory 10c, and a processor 10d. The devices illustrated in FIG. 15 are coupled to each other through a bus or the like.

The communication device 10a is a network interface card or the like and communicates with other apparatuses. The HDD 10b stores the DB and the program for operating the functions illustrated in FIG. 5.

The processor 10d reads, from the HDD 10b or the like, a program for executing similar processes to those of the processing units illustrated in FIG. 8 and loads the program into the memory 10c, thereby causing a process of performing the functions described with reference to FIG. 8 and the like to operate. For example, this process executes similar functions to the functions of the processing units included in the information processing apparatus 10. For example, the processor 10d reads, from the HDD 10b or the like, a program that has similar functions to those of the preliminary processing unit 21, the operation processing unit 22, the automatic recovery unit 30, and the like. The processor 10d executes the process that performs similar processing to that of the preliminary processing unit 21, the operation processing unit 22, the automatic recovery unit 30, and the like.

As described above, the information processing apparatus 10 operates as an information processing apparatus that executes the method for machine learning by reading and executing the program. The information processing apparatus 10 may also realize similar functions to those of the above-described embodiment by reading the above-described program from a recording medium with a medium reading device and executing the read program described above. The program described in this other embodiment is not limited to being executed by the information processing apparatus 10. For example, the above-described embodiment may be similarly applied to the case where an other computer or a server executes the program and the case where the computer and the server cooperate with each other to execute the program.

The program may be distributed via a network such as the Internet. The program may be recorded in a computer-readable recording medium such as a hard disk, a flexible disk (FD), a compact disc read-only memory (CD-ROM), a magneto-optical (MO) disk, or a Digital Versatile Disc (DVD), and may be executed by being read from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process comprising:
classifying data into a plurality of classes based on a density of the data in a projective space to which source data is projected;
performing data augmentation on first data that is positioned in a region, in the projective space, where data which is positioned in a region of a first class and which belongs to the first class exists at a higher density than a predetermined density and on second data that is positioned in a region, in the projective space, where the data which is positioned in the region of the first class and which belongs to the first class exists at a lower density than the predetermined density; and
setting, in a case where the first data after the data augmentation and the second data after the data augmentation overlap each other in the projective space, a label that corresponds to the first class to first augmentation data obtained by performing the data augmentation on the first data, the second data, or second augmentation data obtained by performing the data augmentation on the second piece of the data, or arbitrary combination thereof.

2. The non-transitory computer-readable recording medium according to claim 1, the process further comprising:
executing machine learning in which the first augmentation data, the second data, or the second augmentation data to which the label is set by the setting is used as an explanatory variable of a machine learning model and the label set by the setting is used as an objective variable of the machine learning model.

3. The non-transitory computer-readable recording medium according to claim 1, wherein
the source data is image data.

4. The non-transitory computer-readable recording medium according to claim 3, wherein
the performing of the data augmentation applies test time augmentation to image data that corresponds to the first data or the second data.

5. The non-transitory computer-readable recording medium according to claim 3, wherein
the performing of the data augmentation generates the first augmentation data or the second augmentation data by executing processing of flipping, Gaussian noise, enlargement, or reduction on image data corresponding to the first data or the second data.

6. A non-transitory computer-readable recording medium storing a machine learning program for causing a computer to execute a process comprising:
classifying data into a plurality of classes based on a density of the data in a projective space to which source data is projected;
performing data augmentation on data that is positioned in a region, in the projective space, where data which is positioned in a region of a first class and which belongs to the first class exists at a lower density than a predetermined density; and
setting, in a case where a position, in the projective space, of the data after the data augmentation is in a region where the data which is positioned in the region of the first class and which belongs to the first class exists at a higher density than the predetermined density, a label that corresponds to the first class to the data, or augmentation data obtained by performing the data augmentation on the data, or both the data and the augmentation data.

7. An information processing apparatus comprising:
a memory; and
a processor coupled to the memory and configured to:
classify data into a plurality of classes based on a density of the data in a projective space to which source data is projected;
perform data augmentation on first data that is positioned in a region, in the projective space, where data which is positioned in a region of a first class and which belongs to the first class exists at a higher density than a predetermined density and on second data that is positioned in a region, in the projective space, where the data which is positioned in the region of the first class and which belongs to the first class exists at a lower density than the predetermined density; and
set, in a case where the first data after the data augmentation and the second data after the data augmentation overlap each other in the projective space, a label that corresponds to the first class to first augmentation data obtained by performing the data augmentation on the first data, the second data, or second augmentation data obtained by performing the data augmentation on the second piece of the data, or arbitrary combination thereof.
